(19) United States
(12) Patent Application Publication
(10) Pub. No.: US 2023/0334187 A1
(43) Pub. Date: Oct. 19, 2023

(54) SIMULATING SUSTAINABILITY METRIC OF MODELED BUILT ENVIRONMENT

(71) Applicant: TRAX.GD CORP., Vaughan (CA)

(72) Inventors: Azam KHAN, Aurora (CA); Simon BRESLAV, Toronto (CA); Nikolas McGlashan, Toronto (CA); Curtis Ho, Toronto (CA); David Gerber, Los Angeles, CA (US)

(73) Assignee: TRAX.GD CORP., Vaughan, ON (CA)

(21) Appl. No.: 17/720,951

(22) Filed: Apr. 14, 2022

(51) Int. Cl. G06F 30/13; G06F 30/20

(52) U.S. Cl. CPC G06F 30/13; G06F 30/20; G06F 2111/04

(57) ABSTRACT

A computer system to implement automated parametric modeling of a built environment and simulating applying a plurality of sustainability metrics to respective modeled built environments.

### BACKGROUND

Sustainability in architectural design process of a building may involve a sustainability certification system (SCS) which may quantify sustainability objectives in form of metrics representing measures corresponding to the sustainability objectives, also resulting in sustainability compliance verification metrics. A sustainability objective may be a task or process, with associated data, metadata, and/or state information, which may be expressed as a metric to be measurable.

An SCS may apply to various phases of a building lifecycle from design to construction, operations, or from repurposing or recycling. Furthermore, an SCS may vary in focus, emphasizing some building aspects more than other aspects.

### BRIEF DESCRIPTION OF THE DRAWINGS

FIG. 1 is a functional block diagram of a computer system to implement automated parametric modeling of a built environment and simulating applying a plurality of metrics indicating sustainability to respective modeled built environments, according to an example;

FIGS. 2A, 2B, 2C and 2D are diagrams of a process of automated parametric modelling of the built environment using the computer system in FIG. 1 with example data, according to an example;

FIG. 3A is narrative diagram of generation a geometric model of a hospital design, in an example;

FIG. 3B is formula diagram of transformed metrics, in an example;

FIG. 4 is a diagram of visualizations of illuminance based on transformed metrics ASE and sDA, in an example;

FIG. 5 is a diagram of Isovist, Obstructed/unobstructed rays, View Factor, in an example;

FIG. 6 is a diagram of a parallel coordinate plot of transformed metrics, in an example;

FIG. 7 is a diagram of standard deviation curves of transformed metrics, in an example;

FIGS. 8A, 8B and 8C are diagrams of a built environment including visual indicators corresponding to respective sustainability metrics applied to the built environment, according to an example;

FIG. 9 is a diagram of correlation matrix showing spearman r values, in an example;

FIGS. 10A, 10B and 10C are diagrams of a generative hospital design including visualization of view quality (L), illuminance (C) and building program design (R), in an example;

FIG. 11 is a functional block diagram of a computer, which is a machine, for implementing examples of the disclosure, according to an example.

### DETAILED DESCRIPTION

Hereinafter, an example of a computer that generates model information of a built environment and simulates a design of the built environment subject to parameterized information of an SCS 100 to dynamically interact with the SCS 100 will be described with reference to the accompanying drawings. Elements having substantially the same configurations are denoted by the same reference numerals in the specification and the accompanying drawings, and thus, a repeated description thereof may be omitted.

Sustainability may refer to concept of intergenerational maintenance of resources involving dimension of environmental, economic and social. Sustainability in design of a built environment, including design of a new construction, or retrofitting of an existing construction, for example, involving an office building, may become a critical concern globally. A built environment refers to indoor and outdoor environment spaces that provide a setting for human and/or machine activity, including residential, commercial, and/or industrial buildings, zoning (for example, types of activity), transportation (for example, streets, sidewalks, open spaces, types of transportation) involving urban, suburban or countryside planning.

A multitude of SCSs 100 may be developed but questions remain as to how to apply information in form of requirements, metrics, to achieve a sustainability objective, that may be expressed in an SCS 100 to a real world built environment, a design of a real world built environment, and how effective sustainability objectives of the SCS 100 may be throughout the built environment lifecycle, for example, in sustainability objectives of energy reductions, material reduction, waste reduction, and/or economics. In an example, an SCS 100 may specify a sustainability related requirement that has criteria expressed in form of a sustainability metric 102 that uses points allocated to compliance with the sustainability metric 102 to calculate scores based on the allocated points to further indicate a certification level under the SCS 100. SCSs 100 may include at least one sustainability objective among sustainability objectives in form of metrics 102 involving structures, including exterior and/or interior, components of the structures, environment, social, health, and economic. In examples, an SCS 100 may be [1] Leadership in Energy and Environmental Design (LEED), developed by the U.S. Green Budding Council (USGBC) (LEED v4 for Building Design and Construction, by U.S. Green Building Council, pp, 1-160 (2019), which is incorporated herein by this reference); [2] WELL Budding Standard (WELL) by the International WELL Building institute (IWBI) (WELL v2, WELL Building Standard, by International WELL Budding Institute, pp. 1-383 (2020), which is incorporated herein by this reference); [3] AIA 2030 Challenge, (2006), The American Institute of Architects (AIA), <URL: https://architecture2030.org/2030_challenges/2030-challenge/> (which is incorporated herein by reference).

However, a technical problem in a computer system to evaluate compliance with a target sustainability metric 102 of an SCS 100 in a built environment is to enable the computer system to become efficient in form of speed and accuracy by causing optimization results of a multi-objective optimizer to converge based upon processing of vast amount of information expressed in a plurality of SCSs that specify a plurality of different, competing, conflicting, sustainability objectives (may also be referred to as goals) that have been quantified in form of sustainability metrics 102, and scores in form of points in a scorecard indicative of compliance with the sustainability objectives, further resulting in enabling automated decision making based on processing information indicative of tradeoffs among sustainability objectives within a single SCS and among a plurality of SCSs, in the architectural design process of a built environment to achieve the target sustainability metric 102. Processing of vast number of permutations involving sustainability objectives within one SCS and among a plurality of SCS to output a prediction indicating whether a built environment may be in compliance with one or more target SCSs involve vast amount of information that cannot reasonably be handled mentally by a human.

According to an example, a computer automatically, dynamically, generates and analyzes metrics indicative of at least one sustainability objective of at least one SCS applied to a built environment within an iterative generative design framework of the built environment to simulate a plurality of designs of the built environment to output a predictive score indicative of a level of compliance with the sustainability objective in at least one SCS.

To help improve sustainability outcomes in a built environment, hundreds of SCSs may be developed. In an example, an SCS, among SCSs, may be a sustainability objective driven process, developed and published by a standards body. The sustainability objectives in the SCS may be in form of a hierarchical checklist and corresponding scores, resulting in a sustainability certification based on the scores. A score in the SCS may be in form of a point corresponding to compliance in the built environment with a sustainability objective in the SCS. In an example, the SCS may have a corresponding scorecard, which is an aggregated score that is systematically derived from a set of scores.

These SCSs may be used to quantify specific measures of sustainability objectives and to verify compliance. An SCS may apply to various phases of a built environment lifecycle from design to construction, operations, and repurposing or recycling. Furthermore, an SCS may vary in focus, emphasizing some built environment aspects more than other aspects. With an increasing complexity of built environment projects, multiple SCSs may be beneficial or, for certain built environments, such as hospitals and manufacturing plants, an SCS may be mandatory.

In the architecture, engineering, and construction (AEC) industry, sustainability efforts subject to SCSs have had an important impact in the sustainability outcomes of built environment projects. However, SCSs may also cause a technical problem in form of generation and handling of vast amount of electronic information representing the SCSs which may add further tasks and complexities to teams developing the built environment projects. In case multiple SCSs are pursued in a built environment project, understanding overlaps, commonalities, and differences in underlying sustainability objectives represented as metrics and requirements among the SCSs, which form a plurality of parametric information dimensions, may be critical, and which cannot be performed mentally by a human and a computer implemented process may also experience inefficiency, for example, time to reach an accurate prediction due to the vast amount of information and vast number of permutations among sustainability objectives, resulting in a plurality of information dimensions within an SCS or among a set of SCSs. For example, the average focus areas emphasized in some SCSs may be, for example, occupant heath by the WELL standard, and reducing resource consumption may be the focus by the LEED standard, but some overlaps exist between WELL and LEED. To help practitioners benefit from overlapping concerns, the WELL certification body has published information listing WELL's certification metrics with each metric classified as ‘Aligned’ or ‘Equivalent’ to a corresponding metric in LEED.

SCS metrics may be qualitative, quantitative, or a mix of both. For example, the way in which a built environment project may impact the biodiversity of the local ecosystem could be stated as quantifiable metrics, such as light pollution levels, or they may be open to interpretation, for example, selecting appropriate plant species for landscaping where native species cannot be readily determined. In other areas, such as Energy Use Intensity (EUI), the metrics may be more strictly quantitative and therefore amenable to automation. In an example, encoding metrics of an SCS to be electronic data driven for computer implemented computation to automate scoring of a certification for the SCS would enable more informed decision making for sustainability, during the design process. Furthermore, the process of encoding the metrics would involve making explicit choices about what information is needed and when decisions and commitments for compliance with an SCS may need to be made.

There may be technical problems in computer implementation to automate the calculation of levels of adherence to sustainability objectives specified in SCSs. First, an example technical problem may be that an SCS may be expressed in plain English text form which may not precisely express requirements, to express an intent of the requirement expressed in the SCS, so that a design team of persons may need to interpret a meaning of a requirement. In an example, a technical solution of encoding sustainability objectives of SCSs into a computer implemented automated parametric modeling of a built environment and simulating applying a plurality of sustainability objective functions to respective modeled built environments in form of generative design of the built environment, improves the technical field of computerized automation, because interpretation of the sustainability objectives may become automated to be explicit, measurable, and provide semantic transparency to users, for example, a broader set of stakeholders of the built environment.

Second, an encoded SCS may be re-used on multiple built environment projects, reducing duplication of effort and manual labor, avoiding re-interpretation of the sustainability objectives of the enclosed SCS, and reducing the need for cross-disciplinary expertise. At the same time, an encoded SCS would increase the technical benefits of using computer built environment simulators embedded in computations, which may further improve the technical field of automating compliance calculation.

Third, the automation of SCS compliance enables higher-level automation through the use of goal-seeking meta-heuristics such as the genetic algorithms that may be used in generative design processes of built environments. With generative design level of automation, the technical improvements mentioned above may be further amplified. In an example, an SCS goal may be the American Institute of Architects (AIA) 2030 Challenge, which scores energy performance relative to a moving baseline to be carbon neutral by 2030. The generative design level of automation improves the automation technology so that for the AIA 2030 Challenge, instead of a points system, a metric may be evaluated as a percentage relative to a target Energy Use Intensity (EUI) baseline.

Finally, while the intent of SCSs may be to improve sustainability, in case of point systems that SCSs employ, a point system may reward some aspects of a built environment project more than others. Over time, by gathering data to quantify the sustainability performance of built environment projects, the actual outcomes could be compared to the points originally awarded. Alternatively, with an automated process using built environment simulators, an outcome-based re-weighting of the point scoring systems could greatly increase positive impact on sustainability. Taken together, these technical solutions may encourage standards bodies to develop corresponding automation tools when updating standards or developing new standards.

As an example, a technical problem may be reducing material consumption in developing built environments with sustainable outcomes, given overlapping requirements of multiple SCSs. In an example, a technical solution is a computer implemented automated parametric modeling of a built environment and simulating applying a plurality of sustainability objective functions of a plurality of SCS to respective modeled built environments to enable consideration of issues related to design space exploration based on the requirements of the SCSs, resulting in reduction of material consumption, which may further lead to a reduction in cost and complexity of developing the built environment.

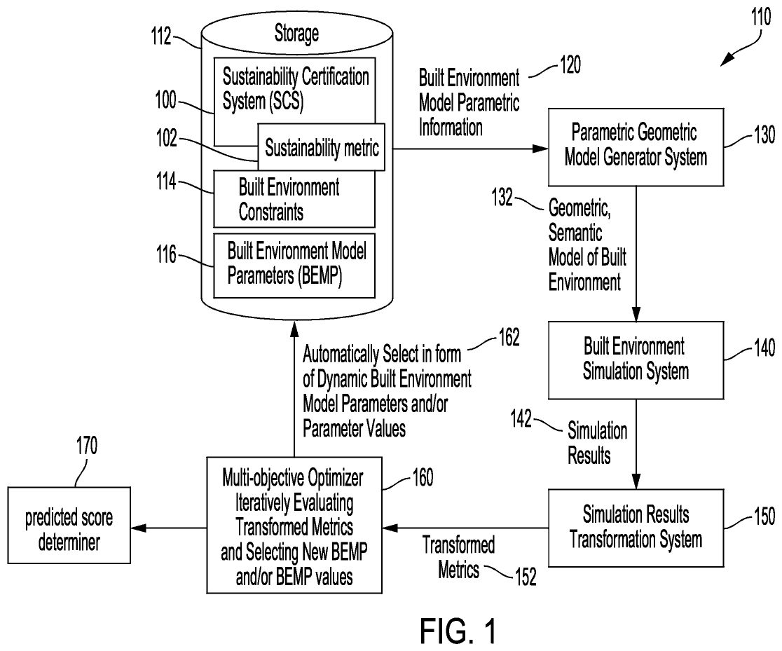

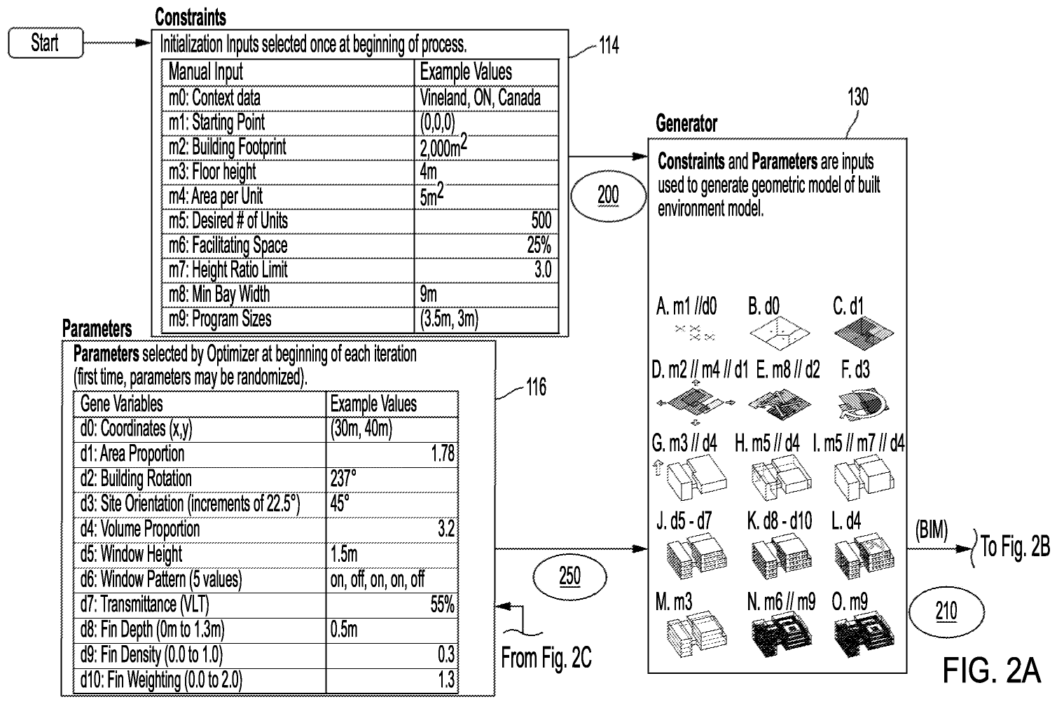

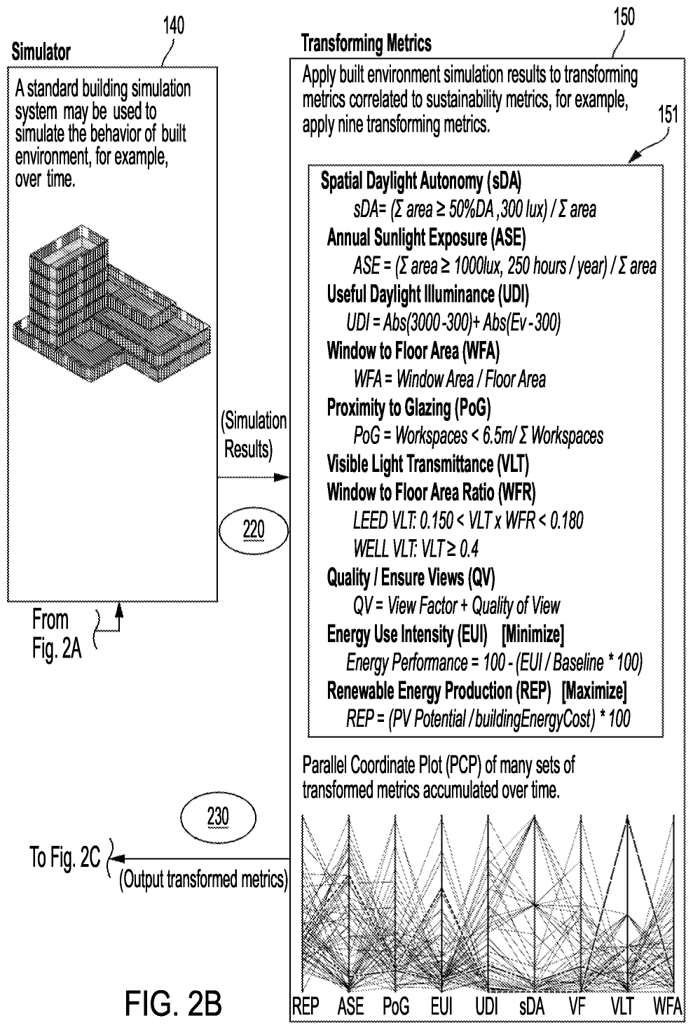

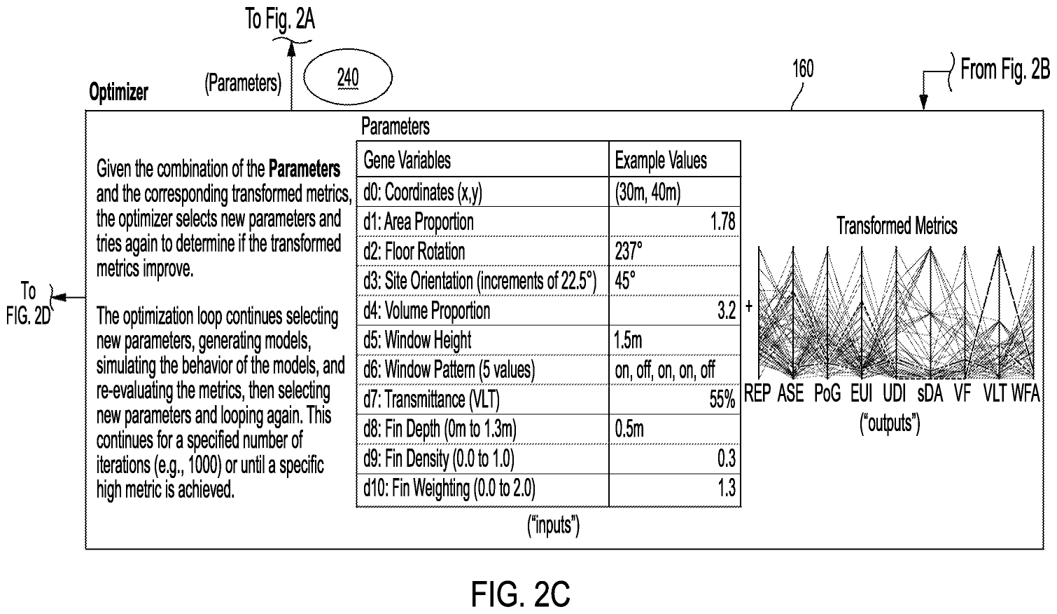

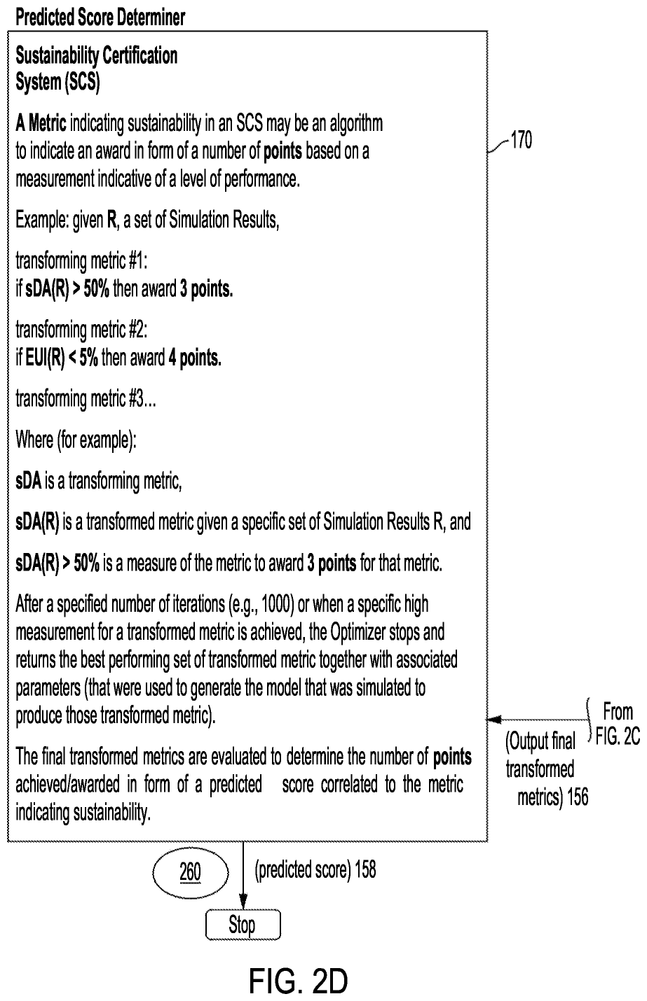

FIG. 1 is a functional block diagram of a computer system to implement automated parametric modeling of a built environment and simulating applying a plurality of metrics 102 indicating sustainability to respective modeled built environments, according to an example. In an example, automation is described given overlapping sustainability metrics 102 of multiple SCSs 100, and simulation in form of design space exploration based on the SCSs 100. An example implementation of LEED, AIA 2030 Challenge, and WELL standards as the SCSs 100 as applied to a hypothetical hospital building to be designed as a built environment (see FIGS. 2A-2D, 4, 5, 8A-8C, and 10A-10C) in a generative built environment design computer system 110 is described as an example.

Referring to FIG. 1, the generative built environment design computer system 110 may simulate optimizing sustainability metrics 102 of at least one SCS 100 among plural SCSs 100 in a built environment. The generative built environment design computer system 110 may include a machine readable storage 112 to store information indicative of SCSs 100, constraints of a built environment 114 and built environment model parameters 116. A constraint of the built environment 114 in form of a built environment context may include constraint type parameters impacting properties of a built environment, for example, a geometry as a property of the built environment in case of a building. In an example, the built environment constraints 114 may remain static during at least one iteration or a set of iterations, and may include a physical location; topology; cost; time; municipal requirements (regulations); project mission and vision (tasks); or organization, personnel information; which may be expressed in form of a parametric dimension. In an example, constraints of a built environment 114 may be initial parameters input either manually or automatically to launch the iterative process of the generative built environment design computer system 110, and such initial input parameters may be dynamically adjusted to launch a plurality of varying simulations of sustainability metrics of respective geometric models of built environments 132. A combination of the built environment constraints 114 and the built environment model parameters 116 may form built environment model parametric information 120 to be input to a parametric geometric model generator system 130 to generate a geometric model of the built environment 132.

The parametric geometric model generator system 130 may be an automated built environment modeling computer program to generate a digital geometric model of the built environment 132 based on the built environment model parametric information 120. In an example, parametric geometric model generator system 130 may include algorithms to model a structure of a building including exterior and interior space models. Regarding an interior geometric model, for example, an algorithm to layout desks in an office building could take a floor plan as input, together with physical object measurement dimensions, such as desk sizes, and could generate a new layout with desks positioned on the floor plan. The geometric model of the built environment 132 may include at least one type of semantic information from among Building Information Modelling (BIM), City/Campus Information Model (CIM), and BIM, CIM, and Geographic Information System (GIS).

In an example, BIM may be a built environment modeling technology involving generation of digital representations of physical and functional properties of built environments. A built environment and its models may encompass resources, including tangible (physical) resources and/or intangible resources. In an example, a built environment model may encompass components of a building, including physical objects in the interior of the building, that are represented in an object-oriented way through information objects, which contain data, including attributes, geometric information, material properties, and parametric rules, together with meta-data describing their object type.

In an example, GIS may be a system that creates, manages, analyzes, and maps types of data. GIS may connect data to a map, integrating geospatial location data with a variety of types of descriptive information.

In an example, CIM may integrate BIM and GIS datasets resulting in semantic 3D city models that can contain contextual project data—static or dynamic, spatial on nonspatial—from buildings, to roads and public spaces, to streetlights, to people on the street.

In an example, the parametric geometric model generator system 130 involves algorithms to generate a geometric model of a physical object, for example, a built environment, or to configure an existing geometric model of a built environment, given a set of input built environment constraints 114 and a first set of built environment model parameters 116 among sets of built environment model parameters 116.

The parametric geometric model generator system 130 is configured to generate a realistic built environment model 132, for example, a hospital building, with real world modeled exterior and/or interior spaces that can form energy zones, floors, windows, including associated materials, physical objects, such as shading systems, and real world environment information such as geographic location, weather information, time and season information, that may influence sustainability objectives of SCSs and needed by a built environment model simulator to calculate simulation results 142 corresponding to a target sustainability objective of target SCS 100 when applied to the built environment model 132. For example, in case daylight and energy performance were classified as selected sustainability objectives from plural SCSs 100, if a built environment 132 did not have windows, many of the simulation results 142 would not have useful values.

In an example, a physical object may have a number of parameters that determine overall properties of the physical object, such as measurement dimensions including width, depth, height, volume, interior space properties. In case of a building, a number of floors in the building may be used to determine interior properties of the building. Given a set of constraints 114 fora physical object that is to be built, and a set of built environment model parameters 116 to specify a massing system as overall configuration of the built environment, specific designs of the physical object may be generated by the parametric geometric model generator system 130 to evaluate a variety of the designs based on different sets of built environment model parameters 116, or different values corresponding to the building model parameters 116.

In an example of a campus as a built environment, some physical resources may be arranged hierarchically, for example, buildings; physical objects, for example, equipment, components, furniture, or like; while other physical resources and/or intangible resources, for example, roads, bridges, power infrastructure, health, economics or costs, or environmental sustainability, or like, may be associated in form of an attribute of another physical resource.

The geometric model of the bunt environment 132 may be input to a bunt environment simulation system 140 to simulate a behavior of the modeled built environment, including exterior and interior models of spaces. In an example, in case of an interior model, the built environment simulation system 140 may perform a design simulation to generate a new layout with desks positioned on the floor plan. In an example, a simulation may be over a time period. In an example, the built environment simulation system 140 may be a standard simulator corresponding to a target sustainability metric 102 among sustainability metrics 102 applied to the built environment model parametric information 120. In an example of daylight and energy performance as the target sustainability metric 102, CLIMATESTUDIO with ENERGY PLUS may be used as the built environment simulation system 140 from within the GRASSHOPPER visual programming tool.

First simulation results 142, among simulation results 142, of the built environment simulation system 140 based on the built environment model parametric information 120 including the first set of built environment model parameters 116, may be input to a simulation results transformation system 150 to first transform the first simulation results 142 into a first set of transformed metrics 152 correlated to the target sustainability metric 102. The simulation results transformation system 150 includes transforming metric functions 151 correlated to the sustainability metrics 102. In an example, a function may be in form of a computer implemented algorithm. In an example, the transforming metric functions 151 may be formulas (1)-(9) as nine transforming metric functions 151 (discussed below) that transform the simulation results 142 into transformed metrics 152 by applying a set of transforming metric functions 151 to the simulation results (R) 142. In an example, a transforming metric function 151, such as sDA (1), transforms the simulation results 142 to a percentage and which may be expressed as sDA(R) (1)). Therefore, given a set of simulation results 142, applying a transforming metric function 151 results in a transformed metric 152 correlated to a plurality of scores of the sustainability metrics 102 in the SCSs 100.

In an example, one or more transformations in form of transforming metric functions 151 may be applied to the built environment simulation results 142, resulting in creating the first set of transformed metrics 152, among sets of transformed metrics 152, in form of a first training set of transformed metrics 152, based on the first modified transformed set of simulation results 142, input to a multi-objective optimizer 160.

In an example, a multi-objective optimizer 160 may be a standard optimizer capable of optimization of multiple input objectives. In an example, a multi-objective optimizer may be NSGA-II (by: Deb, K.; Pratap, A.; Agarwal, S.; Meyarivan, T. (2002). “A fast and elitist multiobjective genetic algorithm: NSGA-II”. IEEE Transactions on Evolutionary Computation. 6 (2): 182. CiteSeerX 10.1.1.17.7771. doi:10.1109/4235.996017).

The multi-objective optimizer 160 may be trained in a first stage as a first iteration using the first training set of transformed metrics 152, resulting in the multi-objective optimizer 160 being trained to select a second set of built environment model parameters 116 to obtain a second set of transformed metrics 152 in form of a second training set of transformed metrics (new training set) 152 including the second set of built environment model parameters 116 and a second modified set of simulation results 142 to be input to the simulation results transformation system 150 to generate a third set of transformed metrics 152 to be input to the multi object optimizer 160, resulting in automatically, dynamically improving in a second stage as a second iteration, the first set of transformed metrics 152 of the built environment in form of a second set of transformed metrics 152 of the built environment 152, thereby causing training of the multi-objective optimizer 160 to obtain a target final (for example, the third set of transformed metrics 152 among sets of transformed metrics 152.

In an example, the simulation results transformation system 150 performs a transformation 230 (FIG. 2B) of a built environment simulation results 142 into a transformed metric 152 corresponding to a target sustainability metric 102. The transformation 230 transforms the built environment simulation results 142 by applying transforming metrics 151 so that a resulting transformed metric 152 functions as an objective for a multi-objective optimizer 160 rather than directly using the target sustainability metric 102.

In an example sustainability metrics 102 may be a value, state, threshold range, or an ordered set of values as an achievement level, to be achieved within an attribute (or parameter) dimension (for example, a specified constraint; location; time; weight; weather, for example, temperature; cost; a resource; or like information indicative of a parameter dimension affecting the sustainability metric 102). Therefore, transformation 230 may be needed, because the sustainability metrics 102 may be in form of integer type scores, which may provide less responsive feedback during iterations to the multi-objective optimizer 160. In an example, a sustainability metric 102 may quantify to encompass plural required and/or optional sustainability objective and have associated logic that defines which combination of the required and/or optional objectives may be permitted as a valid sustainability metric combination. Such valid sustainability metric combinations may need to be considered to represent a specific subset of sustainability metric 102 encompassed by a sustainability objective.

Each SCS 100 may be expressed in form of a set of sustainability metrics 102 (also referable as sustainability goals, or sustainability objectives) that are to be achieved. Sustainability metrics 102 may be in form of values including true or false, may be an integer value interpreted as a number of points achieved, or continuous values such as a percentage of compliance level achieved. Sustainability metrics 102 may also be formulas that employ analytics to determine a level of compliance to a sustainability metric 102.

In an example, to benefit from automation provided by a multi-objective optimizer 160, sustainability metrics 102 may be transformed by transforming metrics 151 into normalized continuous values within a range of values suitable for the optimizer 160 so that values of input data can converge into obtaining an optimized data value. In an example, the transforming metrics 151 transform the simulation results into range of values between 0 and 100 in form of percentage (%), or a range of values including at least 100 values, such as 0.0 to 1.0, or 0.0 to 500.0, resulting in transformed metrics 152 with more information detail so that the multi-objective optimizer 160 may interpret whether a transformed metric 152 in form of an outcome is becoming more compliant. That is, sustainability metrics 102 represented as integer values or as binary values may not provide sufficient detailed information to the multi-objective optimizer 160, so that applying transforming metrics 151 may be needed. In an example, the transforming metrics 151 may be functions which take as input simulation results corresponding to plural combined design spaces (for example, area of a target area(s)) within a built environment and output a transformed metric 152 which is within a sufficiently large range of values to cause the optimizer 160 optimize an input transformed metric 152 within the range of values set up in the optimizer 160.

Therefore, in an example, transformed metrics 151 may correlate to sustainability metrics 102 based on transforming metrics 151 using the simulation results (R) which simulate a target sustainability metric 120 applied to a geometric model of a target built environment 132, resulting in a mapping of the sustainability metrics 102 to corresponding larger and more detailed transformed metrics 152 information in form of computational analytics designed to extract meaningful information from the larger and more detail data sets and which is processable by a multi-objective optimizer 160 to converge for optimization of transformed metrics 152 which correlate to predicted points in the target SCSs 100.

In an example, the transformed metrics 152 cause the multi-objective optimizer 160 to analyze large sets of data produced by a number of built environment model simulators 140. Standardized built environment model simulators 140 may exist to simulate attributes of the built environment mode 1321, for example, lighting, thermodynamics, or occupancy patterns in the built environment. These built environment model simulators 140 produce simulation results 142 which are large datasets that may be multi-measurement and/or parameter dimensional, so, for example, may include spatial and/or temporal data sets.

In an example, a transforming metric 151 may be a computed analytic based on the simulation results 142 from the built environment model simulation system 150, and resulting transformed metrics 152 may be continuous valued analytics that can be used efficiently in a multi-objective optimizer 160. In an example, a transformed metric 152 may be a continuous, or quantized, value that can indicate a linearly evaluated level of adherence towards a sustainability metric 102.

In an example, the score transformation by the simulation result transformation system 150 causes a mapping of the simulation results 140 to sustainability metrics 102 in a way that would be useful to a multi-objective optimizer 160. In an example, a technical benefit in form of an improvement to the optimization software technology is that a multi-objective optimizer 160 can work normally to attempt to improve the transformed metrics 152 which indirectly improves compliance levels for the SCS goals represented by the transformed metrics 152.

In an example, a technical improvement is applying a combination of built environment constraints 114, BEMP 116, parametric geometric model generator system 130, and simulation results transformation system 150 to leverage standard systems of built environment simulation system 140 and multi-objective optimizer 160 to successfully map in form of correlating a larger set of target sustainability metrics 102 of plural SCSs 100 to a smaller set of transformed metrics 152 from which, at 170, predicted points can be determined, by causing an optimization process of the multi-objective optimizer 160 to converge to indicate a desired transformed metric 152, resulting in output of at least a built environment model 132 having a predicted score based on the transformed metrics 152 which correlate with the target sustainability metrics 102 in the plural SCSs.

FIGS. 2A, 2B, 2C and 2D are diagrams of a process of automated parametric modelling of the built environment using the computer system in FIG. 1 with example data, according to an example. In an example, design of a hospital building is used as a built environment design to which sustainability metrics 102 of plural SCSs 100 are applied through computer simulation. A generative built environment design computer system (design system) 110 is the basis to analyze sustainability metrics 102 of an SCS 100 according to an example. The analysis by generative built environment design computer system 110 may be launched from a series of input built environment constraints 114 and dynamic bunt environment model parameters 116, as shown in Table 1. Built environment constraints 114 may be input by a user or obtained from a file, whilst dynamic built environment model parameters 116 inputs (gene variables) may be selected by an evolutionary (trained) multi-objective optimizer 160. Throughout the description herein, the built environment constraints 114 from Table 1 are indicated with an ‘m’ as in m0, and the dynamic built environment model parameters 116 with ‘d’ as d0, for example.

Table 1 is an example table of inputs to the design system 110. Left: constraint settings 114 (with values noted). Right: dynamic inputs 116 (gene variables). In an example, m0: context data is set to Vineland, Ontario, Canada. In an example, the geometric measurement dimensions of m1-m4 and m8-m9 are in metric (m).

TABLE 1

| | |
|---|---|
| m0: Context data (Vineland, ON) | d0: Coordinates (x, y) |
| m1: Starting Point (0, 0, 0) | d1: Area Proportion |
| m2: Building Footprint (2,000 m²) | d2: Building Rotation |
| m3: Floor Height (4 m) | d3: Site Orientation |
| m4: Area per Unit (5 m²) | d4: Volume Proportion |
| m5: Desired # of Units (500) | d5: Window Height |
| m6: Facilitating Space (25%) | d6: Window Pattern |
| m7: Height Ratio Limit (3) | d7: Transmittance (VLT) |
| m8: Min Bay Width (9 m) | d8: Fin Depth |
| m9: Program Sizes (3.5 m, 3 m) | d9: Fin Density |
| | d10: Fin Weighting |

Referring to FIG. 2A, at 200, prior to any building geometry modeling for the hospital, the design system 110 requires trace amounts of context m0. In an example, EnergyPlus Weather (EPW) information may be used to perform an environment-based simulation. In an example, the built environment project is sited in Niagara, Ontario, and data from the closest weather station, Vineland, Ontario, may be used.

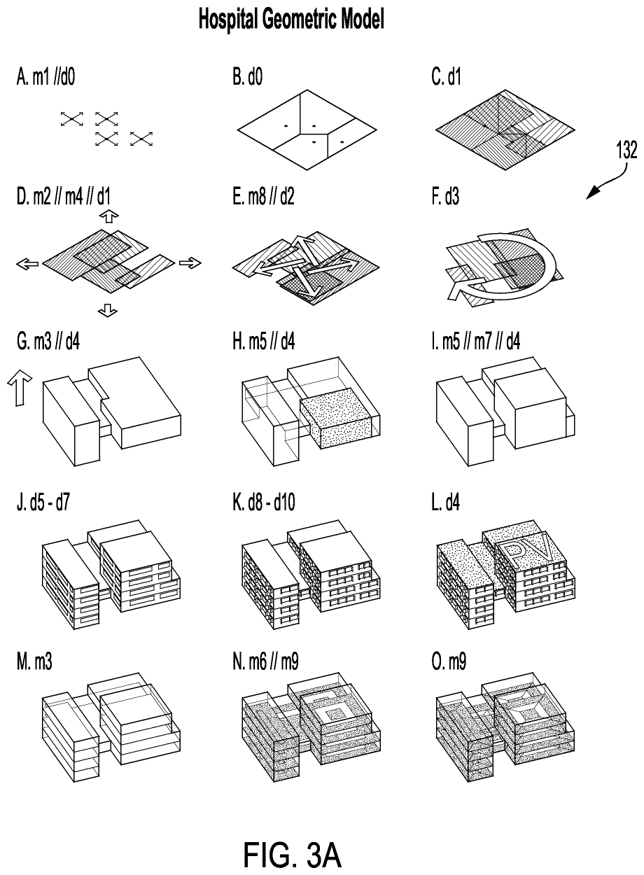

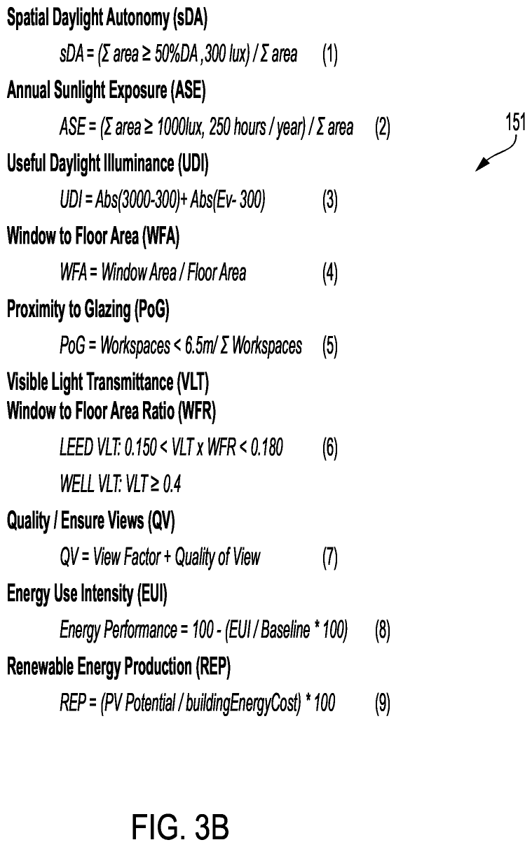

FIG. 3A is narrative diagram of generation of a geometric model of a hospital, in an example. In an example, the parametric geometric model generator system 130 (geometry system) represents a massing system, and at 210, the geometry system 130 digitally models the hospital, resulting in a geometric model 132 of the hospital. In an example, the geometry system 130 may originate from a single point m1, which establishes a boundary. From m0, four points are plotted, determined by d0 (see FIG. 3A, image A). The generated points are used as the origin of Voronoi cells (FIG. 3A, image B). The extent of each cell is used to create a bounding box, generating a rectangular form (FIG. 3A, image C). This provides areas with varying aspect ratios with limited inputs.

A grid is generated every 3 m on a plane of rotation. This may restrict areas from becoming too small for programming or being created too far from each other. A corner may be picked for each shape and moved to a closest point. A generated base area of areas may be rotated about the shared centroid by increments of 22.5° (to restrict the design space), by a dynamic rotational angle d3 (FIG. 3A, image F).

Based on the building footprint area m2 input, each shape as a floor plate is prescribed a portion of the total area, scaled to size (FIG. 3A, image D) and governed by d1. Each area (also referred to as floor plate) may be subjected to individual rotations around the collective centroid using inputs from d2 (FIG. 3A, image E). To restrict the design space, these increments may be set at 90°.

Creating Volume: The area shapes may be extruded based on their volume proportions d4, with the sum being determined by the desired number of interior physical objects (in this case, hospital beds) m5 multiplied by the floor height m3 (FIG. 3A, image G).

Window Pattern: The floor levels partition the facade to establish a repeated pattern (FIG. 3A, image J). Each face width is divided at 2 m intervals to create potential window areas. These potential windows may be divided into five groups that can be either on or off, interchangeably d6. The window heights may also dynamically controlled d5, creating a glazing system that determines the window to wall ratio.

Vertical Shading System: Vertical fins may be placed in front of the windows to act as solar shading devices (FIG. 3A, image K). The depth of the fins can range from 0 to 1.3 m d8, in intervals of 0.3 m. The number of fins may be a dynamically controlled range d9, which is paired with a weight factor d10 that can increase the relative density of fins on the south-facing facade.

Assigning Floor and Building Program (Purpose): The massing system is populated with floor slabs that are spaced according to the floor height m3 (FIG. 3A, image M). In an example, the interior of the building may be populated with patient rooms, circulation spaces, and offices/specialist areas. These built environment programs specifying interior spaces may be established by creating multiple offsets from the original floor plates. Based on typological precedent, the patient rooms were placed around the shape's perimeter, the circulation is then offset from the resultant patient rooms, and the remaining space of the shape is identified as interior offices/specialist areas m9 (FIG. 3A, image N).

Subdividing Energy Zones: The resulting masses may be split at the corners into groups of rooms that originate from the same offset edge (FIG. 3A, image O). The rooms may define climate zones in the built environment geometric model 132, which may be applied to energy modelling simulations by a built environment simulation system 140. Other surfaces, for example, walls, roofs, may define photovoltaic (PV) panel zones (FIG. 3A, image L), which may be applied to energy modeling simulations by a built environment simulation system 140.

In FIG. 2B, at 220, the built environment simulator 140 simulates a behavior of a geometric built environment model 132 based on classified sustainability objectives from the SCSs, for example, the daylight and energy performance sustainability classifications. The built environment simulator 140 generates simulation results 142. At 230, the simulation results transformation system 150 applies transforming metrics 151 to the simulation results 142 to obtain transformed metrics 152.

In FIG. 2C, at 240, the BEMP 116 and the transformed metrics 152 may be input to the optimizer 160. The optimizer 160 given the combination of the BEMP 116 and transformed metrics 152, performs an optimization process to select new built environment model parameters 116 to determine in a next iteration whether the transformed metrics 152 improve. In an example, the optimizer 160 may search for a combination of an optimized transformed metric 152 and BEMP 116. In FIG. 2C, at 240, if the transformed metrics 152 have sufficiently improved, at 260, final transformed metrics 156 are input to a predicted score determiner 170. The final transformed metrics 156 may be evaluated by way of a conversion to determine a number of predicted points that may be achieved, or awarded, in form of a predicted score 158 correlated to the metric indicating sustainability.

In an example, daylight and energy performance were classified as selected sustainability objectives represent in form of a plurality sustainability metrics 102 from plural SCSs 100 for simulation by a built environment simulation system 140 to apply the plurality of sustainability metrics 102 corresponding to daylight and energy performance to respective modeled built environments of the hospital. The sustainability objective were classified for selection due to their potential conflicting points allocated when simultaneously complying with the sustainability metrics 102. For example, while the former is expected to benefit from an increased window to wall ratio, the latter would improve if there were no windows. Both daylight and energy performance require simulations to serve as documentation for accreditation through scores. As a result, these classifications may be particularly aligned with automation and optimization. In an example, ClimateStudio with EnergyPlus was used as a built environment simulator 140 from within the Grasshopper visual programming tool. In an example, Wallacei X was used as a multi-objective optimization system 160 which implements the genetic algorithm NSGA-H.

Individual transforming metrics 151, described below, act as objectives for the optimizer 160 rather than directly using the sustainability indicators 102. This is because SCS points, such as the LEED 4.0 and WELL points to obtain a score, are integers, which give less responsive feedback to the optimizer 160 for partial results. To describe the number of certification points achieved by a specific design, the notation xPy, starting with the number of elective points achieved (x) followed by the number of prerequisite (P) points achieved (y). For example, while the WELL standard certification allows for up to 16P5, in an example, a subset of the WELL standard for illuminance was implemented so the best score the design could achieve would be written as 6P4. This notation may help differentiate designs that may have the same total number of points, but where one may meet more prerequisites than the other.

In an example, transforming metrics 151 (see FIG. 3B, formulas (1)-(9), resulting in information representing optimizer objectives input to the optimization process of the optimizer are described:

Spatial Daylight Autonomy (sDA): Spatial Daylight Autonomy (sDA) is used by WELL and LEED to measure the ability for a space to operate without the use of artificial lighting during operating hours (typically 8 am-6 pm). In terms of WELL and LEED, the minimum threshold is sDA200, 40% and sDA300, 50%, respectively (see citations [2], [1]). As a result, sDA may be set to be maximized during the multi-objective optimization by the optimizer 160.

sDA=(Σ area≥50% DA, 300 lux)/Σ area (1),

where Σ area is a sum of areas as the space in a geometric built environment model 132

Annual Sunlight Exposure (ASE): ASE is the percentage of an area that receives direct sunlight exposure over a certain threshold. It is often used as an indirect measure for glare and, in turn, visual comfort. The ASE threshold for WELL and LEED is ASE1000,250 (see citations [2], [1]). As a result, ASE may be set to be minimized during the multi-objective optimization.

ASE=(Σ area≥1000 lux, 250 hours/year)/Σ area (2)

Useful Daylight Illuminance (UDI): Illuminance (Ev) is the measure of light that contacts a specific area. While sDA may be set to be maximized and ASE may be set to be minimized, Useful Daylight Illuminance (UDI) exists as a range between 300 and 3000 lux. UDI may be tested during the Spring and Fall equinox at 9 am and 3 pm, producing one average value per equinox (see citation [1]).

UDI=Abs|3000−3001|30 Abs|Ev−300| (3),

where Abs is absolute value

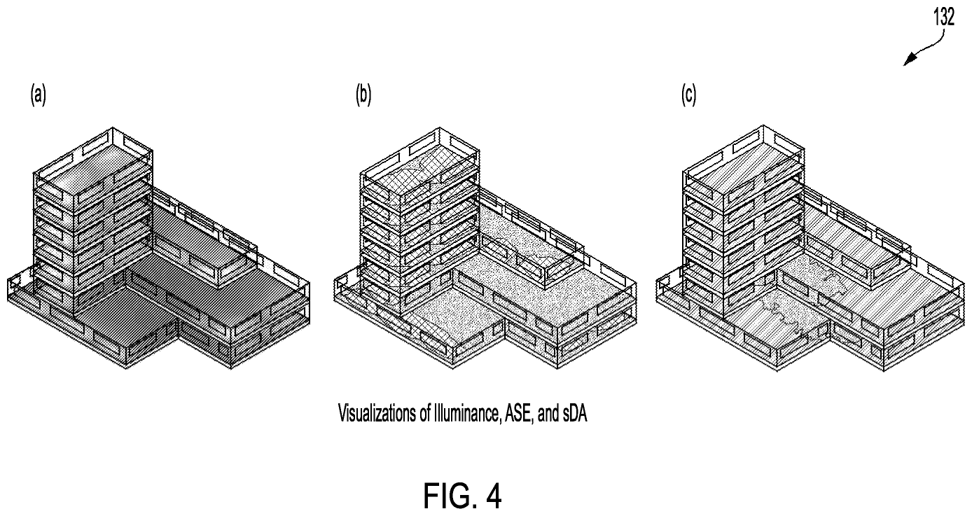

SDA, ASE, and UDI may be calculated using Radiance (see, Larson, G. W., Shakespeare, R., 1998. Rendering with Radiance: The Art and Science of Lighting Visualization. San Francisco: Morgan Kaufmann Publishers, Inc., which is incorporated herein by this reference). A daylight grid with a 0.6 m² resolution was positioned at a seated eye level to evaluate the daylight properties of the geometry (see FIG. 4, image (a) illustrating visualization of illuminance (UDI) (in which darker shaded areas more towards an interior of building may indicate less illuminance vs. lighter shaded areas near windows may indicate more illuminance), image (b) illustrating ASE (in which dotted shaded areas more towards an interior of building may indicate less annual sunlight exposure vs. checkered areas near windows may indicate more annual sunlight exposure) and image (c) illustrating sDA (in which slanted lines areas may indicate more spatial daylight autonomy vs. solid shaded areas may indicate less spatial daylight autonomy)). The simulation by the built environment simulation system 140 may obtain weather data of the site m0, obtain the geometric built environment model 132, and obtain any specified building materials included in constraints 114 and/or BEMP 116. In total, the simulation by the built environment simulator 140 is able to calculate 6 out of 16 possible lighting points and 4 out of the 5 prerequisites points possible for the WELL standard (see citation [2]), while the sDA and UDI metrics may be mutually exclusive in LEED and offer a maximum of 2 points (for healthcare) (see citation [1]).

Window to Floor Area (WFA): WFA establishes a ratio between the depth of the floor plate and the corresponding floor height. As a WELL prerequisite, WFA requires a transparent envelope glazing area to be no less than 7% of the floor area for each floor level. WFA also offers one potential point when greater than 10% and combined with the advanced visible light transmittance (VLT) requirement (see citation [2]). In contrast, LEED requires a glazing construction with a lower U-Value for any WFA over 15% (see citation [1]), but in an example, this was not included in the simulation.

WFA=Window Area/Floor Area (4)

Proximity to Glazing (PoG): Proximity to Glazing (PoG) relates to proximity of physical objects to exterior glazing. In the hospital example, PoG may measure the distance of every hospital bed and desk to exterior glazing. This transformed metric 151 correlates to a requirement of WELL and offers a maximum of 1 point when combined with the advanced requirements of VLT and WFA (APoG) (see citation [2]). As a prerequisite, 30% of all workstations must be within 6 m, while the enhanced point requires 70% of all workstations to be within 7.5 m of transparent envelope glazing.

PoG=Workspaces<6.5m/Σ Workspaces (5)

APoG=Workspaces<7.5 m/Σ Workspaces (6)

Visible Light Transmittance (VLT): Visible Light Transmittance (VLT) measures the amount of light that is able to pass through a glazing construction. Under LEED, it is required for VLT to be at least 50%, while 40% for WELL (see citations [1], [2]). Both sustainability metrics 102 offer 1 point for VLT, however, it is combined with Window to Floor Area Ratio (WFR) for the LEED equation. VLT is entirely controlled by the dynamic VLT input d7. In an example, this may be the only material based dynamic input in the simulation by the built environment simulator 140. To further encapsulate the entire built environment design process, further development of the dynamic materials may be required.

LEED VLT: 0.150<VLT×WFR<0.180 (7)

WELL VLT: VLT≥0.4 (8)

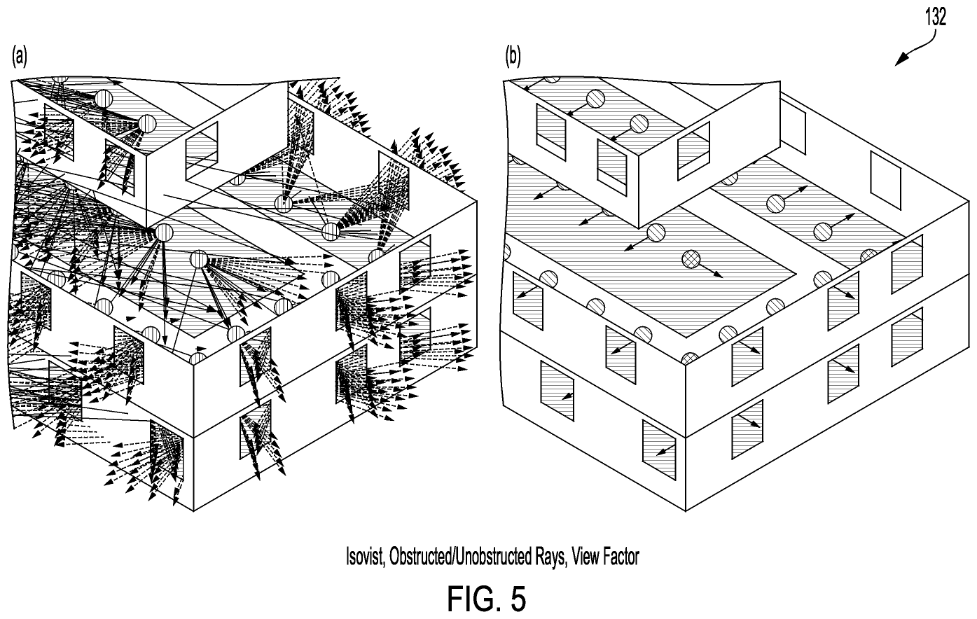

Quality and Ensure Views (QV): Quality/Ensure Views (QV) award 1 point by satisfying two of four requirements in LEED and two of three requirements in WELL. The standards share two quantifiable prerequisites (see Applying LEED and the WELL Building Standard: Strategies for interiors, new buildings and existing buildings seeking dual certification. (2020). 12 pages. <URL: https://standard.wellcertified.com/well-crosswalks>, which is incorporated herein by this reference). The first prerequisite requires a percentage of workspaces having a View Factor of 3 and above, which, for example, may be described by the California Energy Commission (see California Energy Commission (Ed.). (2003). Windows and Offices: A Study of Office Worker Performance and the Indoor Environment. Technical Report. P500-03-082-A-9, 47-51, which is incorporated herein by this reference). The second requires a visual connection to flora, fauna, sky, or ground (away from major roadways). A 3D isovist is placed at patient beds and individual office desks may be used to simulate for both metrics (see FIG. 5, image (a) illustrating a visual of simulation results 142 for isovist, and obstructed and unobstructed rays; and FIG. 5, image (b) illustrating a visual of simulation results 142 for view factor).

QV=View Factor+Quality of View (9)

Energy Use Intensity (EUI): EUI is a measure of energy consumption that has been normalized by the total gross floor area. LEED and AIA require a minimum Energy Performance relative to a baseline model in accordance with ANSI/ASHRAE/IESNA Standard 90.1-2010, Appendix G (see citations [1, 3]). Additionally, LEED awards up to 18 points (19 for healthcare) for enhanced energy performance, relative to the baseline. In an example, the transformed metrics 151 related to energy were calculated using Energy Plus. While EUI may be set to be reduced during optimization, it is then converted to Energy Performance to calculate the LEED and AIA performance.

Energy Performance=100−(EUI/Baseline*100) (10)

Renewable Energy Production (REP): REP may be measured against the total energy cost of the built environment. The total roof area may be calculated for photovoltaic (PV) panel potential. Built environments with an REP that meets 10% of the building energy cost are awarded three LEED points, while built environments meeting 5% are awarded two, and anything above 1% are awarded 1 (see citation [1]). As a result, maximizing renewable energy production may be an objective.

REP=(PV Potential/buildingEnergyCost)*100 (11)

In an example, simulation by the built environment simulator 140 and/or the optimizer 160 may be performed at each iteration, or skipped for an iteration, in the generative built environment design computer system 110, so that simulation results 142 may be input to the simulation results score transformation system 150 a plurality of times with new built environment model parameters 116 as selected by the optimizer 160. In an example, simulation results 142 was run 300 times, comprising 10 geometric built environment model generations of 30 instances of optimization by the optimizer 160. In an example, the goal may be to ensure that a diversity of solutions can be generated to examine extremities of solutions, potential patterns, and to surface issues in optimization by the optimizer 160.

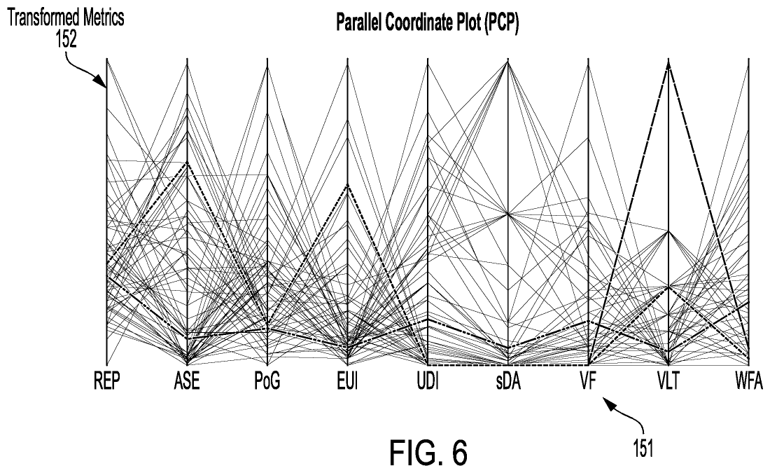

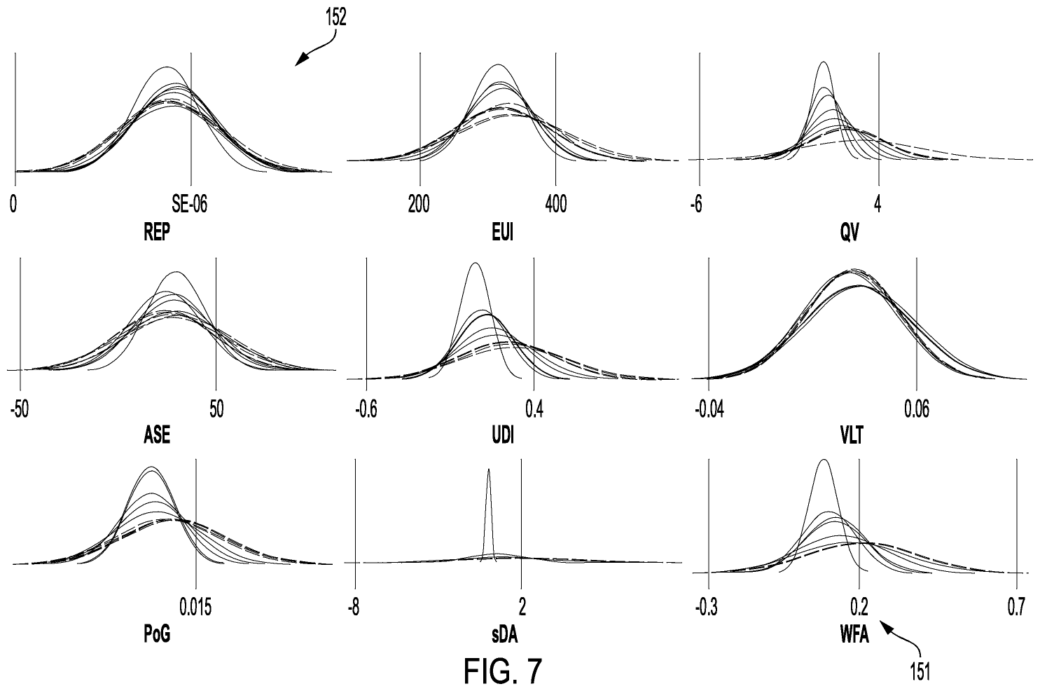

In an example, despite a small sample size, the generative built environment design produced a large variety of fitness values which correlate to predicted scores 158. This is supported by observations in the Parallel Coordinate Plot (see FIG. 6) where a large and distributed spread of values are located within the bounds of each transformed metric 152. FIG. 7 shows a widening standard deviation, indicating that later generations (dashed line curves) are discovering a larger range of fitness values which correlate to predicted scores 158.

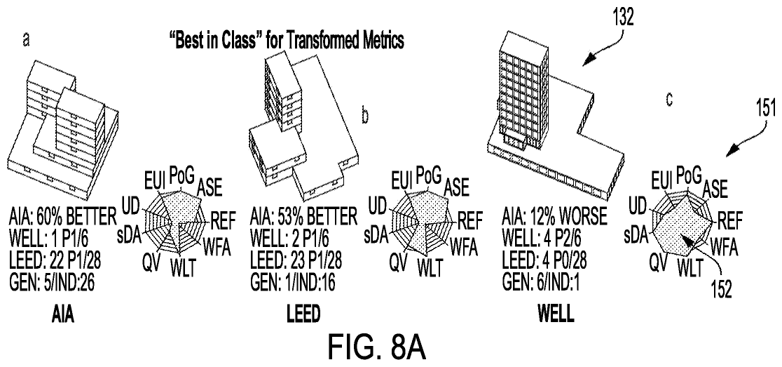

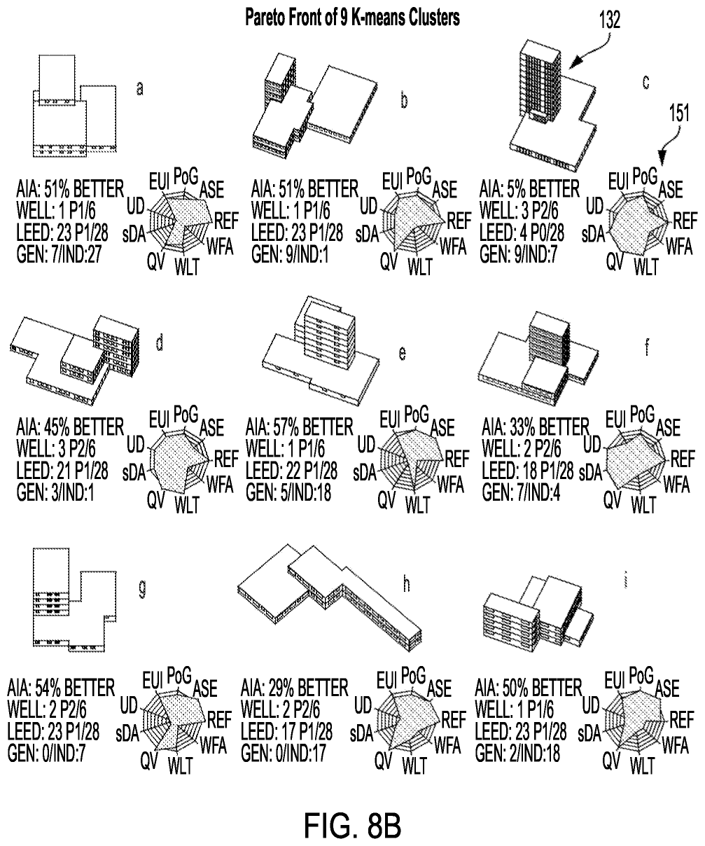

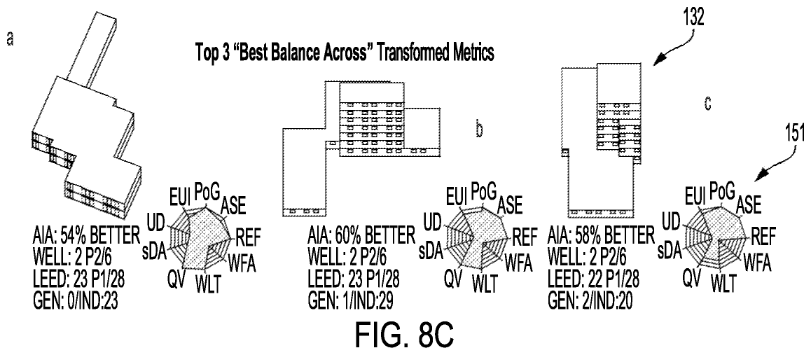

The solutions in FIGS. 8B and 8C are chosen from two selection methods provided by the optimizer 160 whereas solutions in FIG. 8A are the top results, the “Best in Class”, for each transformed metric 152. FIG. 8C exhibits top solutions that have the lowest averaged difference between each fitness rank as transformed metrics 152 representing the “Best Balance Across Objectives” (dashed-two dots line in FIG. 6 for an example of one of these solutions) and FIG. 8B displays solutions found in the pareto front of 9 k-means clusters across the whole population of transformed metrics 152 (dashed line in FIG. 6 for an example of one of these solutions).

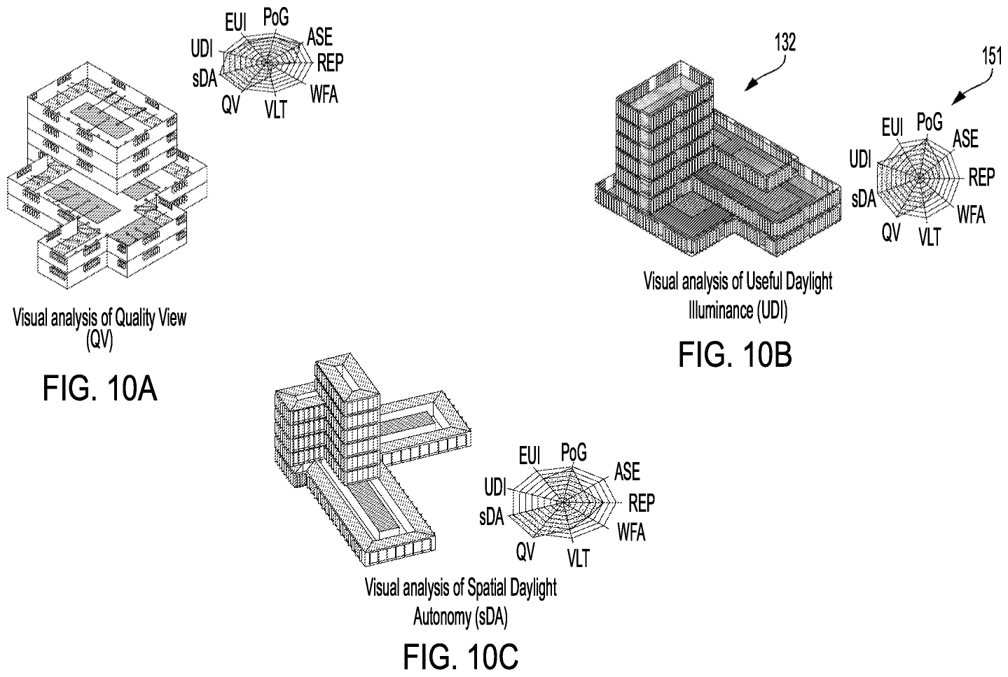

Referring to FIGS. 10A, 10B and 10C, the top scoring results for each transformed metric 152 with upper limits may not have reached the maximum potential points. LEED scores top out at 23P1/28P1 potential points and WELL at 4P3/6 potential points (see FIG. 8B). AIA scores do not have a limit and presented a maximum score of +60%. The upper bound for each optimized transformed metric 152 found in the radar charts in FIGS. 10A-10C from FIGS. 8A-8C (see FIGS. 8A-8C and 10A-10C for radar chart annotations) are REP at 424091.3 kwh/yr, ASE at 1.5%, EUI at 262.7, QV at 100%, UDI at 69.9%, VLT at 100%, sDA at 85.4%, WFA at 60.4% and PoG at 95%. The highest scores in each transformed metric 152 were found throughout the generations whereas solutions with the best balance across transformed metrics 152 were mostly located in the earlier generations.

Architectural Typologies within Solutions: In the example, the selected building solutions can be categorized into four architectural typologies and a series of hybrid solutions. Various typologies can be seen in corresponding FIGS. 8A-8C: Tower and Podium (FIGS. 8A,c, 8B,c, 8B,f, 8B,g, 8C,b, 8C,c), Super-Mass (FIGS. 8B,h, 8C,a), Stepped-Mass (FIGS. 8A,a, 8A,b, 8B,a, 8B,b, 8B,d, 8B,i) and Campus types (FIG. 8B,e). The Tower and Podium solutions hold the highest population and are found in all three selection methods in FIGS. 8A, 8B, 8C, respectively. These solutions also tend to have a higher WELL score and lower LEED scores. Single and Stepped mass typologies with emphases on smaller glazing trend towards a higher performance in LEED scores. The AIA scores lean towards any mass type with smaller glazed areas. The Campus typology has design merit, but may be deemed to not excel in either, as no Campus solutions are in FIGS. 8A or 8C.

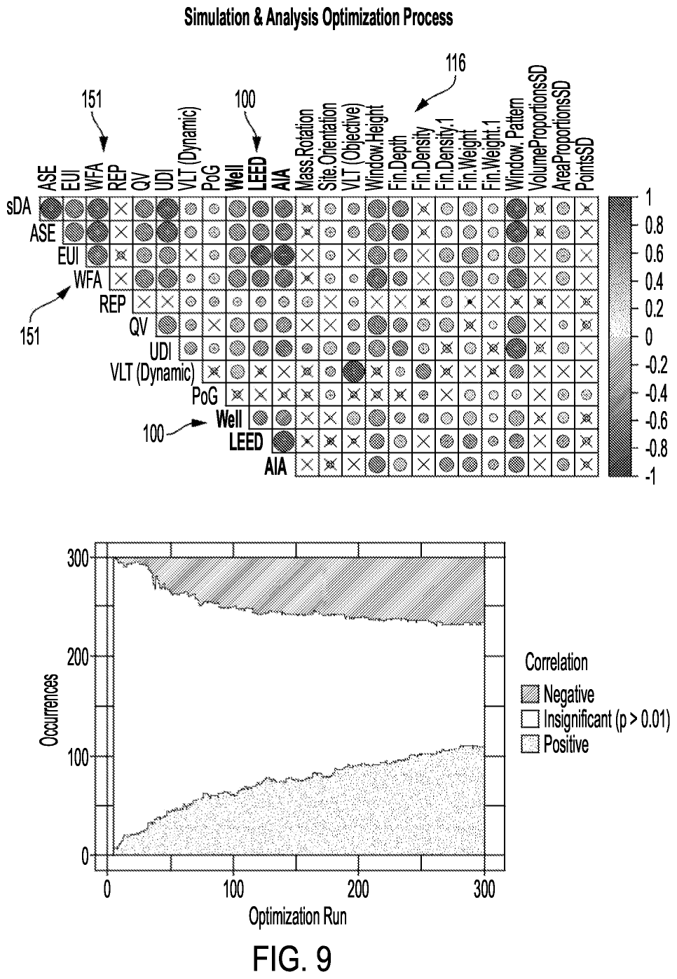

Analytics: The complicated relationship between transforming metrics 151 and dynamic inputs in form of BEMP 116 gives merit to the use of multi-objective optimization processes. FIG. 9 depicts the correlation between transformed metrics 151 and the geometry system inputs 120, where dark grey area indicates a positive correlation and light grey area indicates negative correlation. The circle radius represents the strength of the correlation, while any values marked with a cross are omitted due to statistical insignificance (p>0.01) and likely require additional data or exhibit no clear relationship between the transformed metric 151 and the BEMP 116.

Cross-Metric Sustainability: In FIG. 9 (WELL row) demonstrates a dichotomy between sustainability metrics 102 of SCSs 100, where WELL may be negatively correlated to both LEED and AIA. This relationship reflects the weighted bias of each metric 102. While daylight metrics largely define WELL performance in the simulation, it only represents 2/28 LEED points, and may be neglected in AIA. In turn, a greater EUI reduces the overall score of energy performance metrics but may not affect the WELL standard due to its focus on social factors.

As a result, solutions that seek to maximize daylight values are at the expense of energy performance, ultimately impacting the LEED and AIA scores. While there may be a weak positive correlation between EUI and WELL, high ASE values may prevent this relationship from being linear. While each of these transformed metric 152 indicators are in pursuit of sustainable development, each one may be subject to input parameter bias, resulting in different building typologies.

Dynamic Influence: In FIG. 9, the correlation matrix reveals a slight influence of the parametric geometric model generator system 130 upon the transformed metrics 152. When evaluated in the correlation matrix, buildings with disproportionate areas had better daylight performance and WELL scores but suffered in terms of energy performance. In an example, referring to FIG. 9, a multi-objective optimizer computer program 160 may not efficiently handle more than 4 input objectives to optimize an objective among the objectives, for example, by minimizing or maximizing the objective. In FIG. 9, the insignificant correlations (white area) become fewer as the number of optimization runs increases showing that generative built environment design computer system 110 successfully leveraged a standard optimizer 160 despite having, for example, 9 transforming metrics 151 in form of transformed metrics 152 to be optimized against the BEMP 116 (see FIG. 7) instead of the typical four objectives. In an example, a technical improvement in the field of automated built environment design is use of a multi-objective optimizer 160 to accommodate more than 4 or 5 objectives, namely the transforming metrics 151 cause mapping of hundreds of sustainability goals expressed in plural SCSs 100 into a subset of transformed metrics 151 which correlate to predicted scores indicating compliance with the hundreds of sustainability goals. For example, in case of two SCSs (LEED and WELL), the example described herein may map 24 LEED points and 7 WELL points down to 9 correlated scores by way of the 9 transforming metrics 151. As shown in the FIG. 9 example, the optimizer 160 converges for 31 point values using only 9 correlated predicted point values.

When combined, Window Height d5 and Window Pattern d6 determine the Window Wall Ratio (WWR). As separate transforming metrics 151, these demonstrate a strong correlation to most other transforming metrics 151 in the matrix, a positive impact on WELL, and a negative impact on LEED and AIA. While none of the transforming metrics 151 directly measure WWR, they act as a pivotal interface between the built environment geometric model 132 and sustainability metrics 102.

The simulation results may give rise to the implicit conflicts between sustainability metrics 102, highlighting the imperative for transformed metric indicators 152 to work in tandem throughout the design process.

To enhance the resolution of the optimization process, additional dynamic inputs may include in the built environment model parametric information 120 glazing and material constructions. Incorporating these factors can dynamically influence the relationship between glazing, daylight, and energy performance.

By creating built environment design computer systems that can generate the variations needed to explore the interactions between tradeoffs in sustainability metrics 102 of SCSs, these computational systems can improve automated searching of designs that improve sustainability as verified by standard certifications.

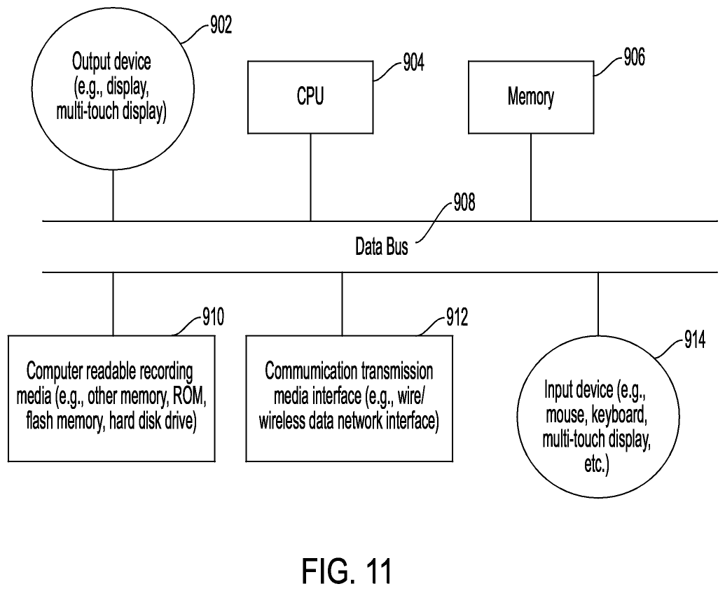

FIG. 11 is an example functional block diagram of a computer, which is a machine, that may implement examples of the disclosure. The described features, functions, operations, and/or benefits of the examples, such as the storage 102, the parametric geometric generator system 130, the built environment simulation system 140, the simulation results score transformation system 150 and the multi-objective optimizer 160 may be implemented by and/or use processing hardware, and/or implemented by software executed by the processing hardware, including by way of networked virtualization technology such as virtual machines on the processing hardware. For example, a processing hardware may be a computing apparatus as illustrated in FIG. 11, which may involve a central processing unit (CPU), or computing processing system (for example, one or more processing devices (for example, chipset(s) including memory), or virtual machines), 904 that processes, or executes, instructions, namely software or program, stored in a memory 906 and/or non-transitory machine readable media 912. The processing hardware may also involve transmission communication interface (network interface) 910, input device 914, and/or an output device 902, for example, a display device, a printing device. The CPU, or computer processing system, 904, the memory 906, the transmission communication interface 910, the input device 914, and output device 902 are coupled (directly or indirectly) to each other, for example, can be in communication among each other through one or more data communication buses 908. The non-transitory machine readable media 912 may be implemented in form of cloud computing.

In addition, a computing apparatus may include one or more computing apparatuses in computer network communication with each other. In addition, a computer processor may refer to one or more computer processors in one or more computing apparatuses. In an example, a computing apparatus is caused and/or configured to execute the described operations. The results produced can be output to an output device, for example, displayed on the display. A computing apparatus refers to a physical machine that performs operations, for example, a computer (physical computing hardware or machinery) that implements or executes instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.)—collectively referred to as hardware processor(s), to achieve the functions or operations being described. The functions described may be implemented in any type of apparatus, or device, that can process, or execute, information, instructions or code.

More particularly, programming or configuring or causing an apparatus or device, for example, a computer, to execute the described functions of the described examples creates a new machine where in case of a computer, a general purpose computer in effect becomes a special purpose computer once the general purpose computer is programmed or configured or caused to perform particular functions of the described examples pursuant to instructions. In an example, configuring an apparatus, device, or computer processor, refers to such apparatus, device, or computer processor, being programmed or controlled by software to execute the described functions.

A program or software implementing the examples may be recorded on machine-readable media, e.g., a non-transitory or persistent machine-readable medium. Examples of the non-transitory machine-readable media include a magnetic recording apparatus, an optical disk, a magneto-optical disk, and/or volatile and/or non-volatile semiconductor memory (for example, RAM, ROM, solid state drive (SSD), etc.).

The words “a,” “an” and “the” are intended to include plural forms of elements unless specifically referenced as a single element. The term “at least” preceding a listing of elements denotes any one or any combination of the elements in the listing. In other words, the expression “at least one of . . . ” when preceding a list of elements, modifies the entire list of elements and does not modify the individual elements of the list. The term “and/or” refers to any one of, or any combination of listed elements.

While this disclosure has been shown and described with reference to examples thereof, it will be understood by one of ordinary skill in the art that various changes in form and details may be made therein without departing from the scope as defined by the claims.

1. A computer, comprising:
a memory; and
a processor to access the memory, the processor is to:
obtain geometric model information of a built environment from a geometric built environment model generator based on a first set of geometric model parameters;
input the geometric model information to a built environment simulation system to simulate attributes of the modeled built environment based on information indicating target metrics quantifying sustainability objectives specified in a standard, resulting in first simulation results;
apply transforming metric functions to the simulation results to transform the simulation results into first transformed metrics which correlate to the target metrics, respectively;
input the transformed metrics into an objective optimizer to train the objective optimizer to select a second set of geometric model parameters to input to the geometric built environment model generator, causing iterative applying of the transforming metric functions to second simulation results to transform the second simulation results into second transformed metrics; and
obtain an optimized transformed metrics, among the second transformed metrics, which correlate to the target metrics.

2. The computer according to claim 1, wherein the transforming metric functions include a number of algorithms to correlate a target metric, among the target metrics, to values within a range of values based on the simulation results, resulting in the transformed metric.

3. The computer according to claim 2, wherein the range of values is a percentage.

4. The computer according to claim 1, wherein the processor is to convert the optimized transformed metrics into predicted points corresponding to points indicating compliance with the sustainability objectives in the standard.

5. The computer according to claim 1, wherein,
the built environment is a building,
the first set of geometric model parameters include constraint information in form of geographic information, and
the processor is to obtain the geometric model information of the building by:
generating model information indicating a structure of the building including external and interior shapes and spaces, based on the first set of geometric model parameters, resulting in the built environment simulation system simulating attributes of the budding based on the first set of geometric model parameters including the constraint information and the information indicating target metrics quantifying sustainability objectives specified in a standard.

6. The computer according to claim 5, wherein the transforming metric functions include a number of algorithms to correlate a target metric, among the target metrics, to values within a range of values based on the simulation results according to a sum of the external and interior shapes and spaces in the structure.

7. The computer according to claim 6, wherein the standard is a plurality of different standards, and the target metric includes a plurality of target metrics from the plurality of different standards, respectively.

8. A non-transitory computer readable medium storing instructions which when executed by a processor cause the processor to:
obtain geometric model information of a built environment from a geometric built environment model generator based on a first set of geometric model parameters;
input the geometric model information to a built environment simulation system to simulate attributes of the modeled built environment based on information indicating target metrics quantifying sustainability objectives specified in a standard, resulting in first simulation results;
apply transforming metric functions to the simulation results to transform the simulation results into first transformed metrics which correlate to the target metrics, respectively;
input the transformed metrics into an objective optimizer to select a second set of geometric model parameters to input to the geometric built environment model generator, causing iterative applying of the transforming metric functions to second simulation results to transform the second simulation results into second transformed metrics; and
obtain an optimized transformed metrics, among the second transformed metrics, which correlate to the target metrics.
